(19) United States
(12) Patent Application Publication
(10) Pub. No.: US 2014/0230677 A1
(43) Pub. Date: Aug. 21, 2014

(54) METHOD OF ALIGNING A STAMP TO A STAMP BACKING PLATE

(71) Applicant: Kurt M. Sanger, Rochester, NY (US)

(72) Inventor: Kurt M. Sanger, Rochester, NY (US)

(21) Appl. No.: 13/771,124

(22) Filed: Feb. 20, 2013

(51) Int. Cl. B41F 27/00

(52) U.S. Cl. CPC B41F 27/005
USPC 101/486

(57) ABSTRACT

A method of aligning a stamp to a stamp backing plate includes mounting a fixture with a first alignment feature to a platen; providing a first stamp with a second alignment feature which matches the first alignment feature; aligning the first stamp to the fixture using the first and second alignment features; transferring the first stamp from the fixture to a first stamp backing plate maintaining registration; providing a second stamp with a third alignment feature which matches the first alignment feature; aligning the second stamp to the fixture using the first and third alignment features; and transferring the second stamp from the fixture to a second stamp backing plate maintaining registration.

### CROSS REFERENCE TO RELATED APPLICATIONS

Reference is made to commonly-assigned copending U.S. patent application Ser. No. ______ (Attorney Docket No. K001417US01NAB0), filed herewith, entitled FLEXOGRAPHIC PLATE MOUNTING; by Sanger; U.S. patent application Ser. No. ______ (K001477US01NAB), filed herewith, entitled SYSTEM FOR MOUNTING A FLEXOGRAPHIC PRINTING PLATE; by Sanger; and U.S. patent application Ser. No. ______ (Attorney Docket No. K001478US01NAB), filed herewith, entitled SYSTEM OF ALIGNING A STAMP TO A STAMP BACKING PLATE, by Sanger; the disclosures of which are incorporated herein.

### FIELD OF THE INVENTION

The present invention relates in general to mounting a flexographic printing plate to a plate cylinder and in particular to mounting plurality of flexographic printing plates to multiple cylinders in registration.

### BACKGROUND OF THE INVENTION

Flexographic printing has been used since the mid 1940s to print onto substrates from corrugated board to hard aluminum. In the mid 40s the anilox roller was introduced which controlled the amount of ink deposited onto the raised flexographic printing plate making the process much simpler to operate while improving the print to print uniformity. State of the art flexographic presses started to use servo motors to drive the plate cylinder, anilox roller, and the impression cylinder in the early 2000s. Servo driven flexographic presses enabled customers to reduce the engagement between the printing cylinder and the receiver which is backed by the impression roller. Kiss impression became popular to reduce the dot gain and produce much finer features while maintaining registration between multiple colors. In the late 2000s Eastman Kodak introduced Flexcel NX flexographic printing plates and processes to produce features as small as 5 um×10 um. Flexcel NX plates with servo driven presses enabled flexographic printing that rivals offset lithography.

These quality improvements all require that the plate is mounted to the plate cylinder in register with the web so that multiple printing operations may be placed in the correct position relative to each other and the printed piece. It is easy, to move the plate cylinder in and out across the web, and advance or retard the rotation of the plate cylinder, on the flexographic press. However, it is not easy to rotate the plate cylinder to accommodate for a rotational error in the position of the plate as this would cause the web to steer towards one side or the other.

The prior art discloses numerous methods to mount a flexographic printing plates. U.S. Pat. No. 8,037,819 (Zanoli et al.) discloses the most popular method of using two cameras mounted in a fixture with the print cylinder. Two alignment marks on the plate are located and aligned to images from the two cameras. Once the plate is aligned it is affixed to the double back tape that is previously applied to the plate cylinder. The cameras are used to check that the alignment marks are in the correct position. If the error is too large then the plate is removed and reattached. Derivatives of Zanoli et al. are used in practice. For instance multiple sets of alignment marks may be on the plate and checked with the cameras to guarantee that the whole plate is mounted properly.

Leader Engineering-Fabrication Inc. produces a machine, Vision Plate Mounter/Proofer® that utilizes cameras to find fiducial marks on the plate. Then the table rotates the plate relative to the plate cylinder and automatically loads the plate onto the cylinder. The vision system enables the fiducials for multiple color plates to be located in different physical positions on the print while still aligning each individual color plate to its respective cylinder and each other.

U.S. Pat. No. 5,345,868 (Baker) discloses forming the flexographic printing plate with a pair of removable alignment projections along its border. These projections are used to form precise apertures which then mate to a mounting device. Punching or drilling a hole in a flexographic printing plate is not a precise process. Flexographic printing plate relief surfaces may be composed of rubber or a photo-polymer such as a butadiene-styrene block copolymer. In addition the flexible relief surface may be glued to a support such as aluminum, plastics such as polyethylene terepthalate, polycarbonate, poly methyl methacrylate, or extruded onto a cloth, to enable the plate to be handled and mounted with minimum stretching of the printing features. Typically the flexible printing surface will compress prior to puncture causing the resulting hole to be slightly misplaced and or misshaped.

Blanding, D. L., “Principles of Exact Constraint Mechanical Design”, Chapter 1, Sections 1.11-1.15, pgs. 10-13, Eastman Kodak Company, OCLC#59624830, (1992), describes kinematic designs which have been widely practiced in the design of precision instruments for well over 100 years. Applying kinematic techniques to mounting multiple flexible printing plates in register to each other is problematic.

### SUMMARY OF THE INVENTION

Briefly, according to one aspect of the present invention a method of aligning a stamp to a stamp backing plate includes mounting a fixture with a first alignment feature to a platen; providing a first stamp with a second alignment feature which matches the first alignment feature; aligning the first stamp to the fixture using the first and second alignment features; transferring the first stamp from the fixture to a first stamp backing plate maintaining registration; providing a second stamp with a third alignment feature which matches the first alignment feature; aligning the second stamp to the fixture using the first and third alignment features; and transferring the second stamp from the fixture to a second stamp backing plate maintaining registration.

In accordance with the present invention, there is provided a method of mounting a flexographic printing plate to a cylinder includes providing a plate with a first alignment feature; providing a fixture with a second alignment feature which matches the first alignment feature; aligning the plate to the fixture; mounting the cylinder in the fixture in alignment with the second alignment feature; and transferring the plate from the fixture to the cylinder maintaining registration.

The present invention is advantaged in that the fixture is simple and inexpensive. The fixture provides a repeatable method of aligning the plate to the cylinder.

Another advantage of the present invention is that it uses the raised relief printing surface to align to the plate cylinder. The raised alignment features are made using the same processes to make the image features at the same time in register.

An embodiment of the invention is further advantaged by utilizing a long raised relief feature on the plate thereby minimizing error due to the flexible nature of the plate.

The invention and its objects and advantages will become more apparent in the detailed description of the preferred embodiment presented below.

### BRIEF DESCRIPTION OF THE DRAWINGS

FIG. 1 is a prior art cross-section of a flexographic relief printing plate.

FIG. 2 is a prior art top view of a flexographic relief printing plate.

FIG. 3 is a cross-section of a flexographic relief printing plate with a raised relief alignment feature.

FIG. 4 is a top view of a flexographic relief printing plate with a raised relief alignment feature.

FIG. 5 is a cross-section showing the mating of a flexographic relief printing plate with a raised relief alignment feature to a fixture with a matching feature.

FIG. 6 is a cross-section showing the alignment of the flexographic raised relief printing plate to the matching features in the fixture and a plate cylinder.

FIG. 7 is a side view of a flexographic relief printing plate and fixture demonstrating an embodiment of the present invention.

FIG. 8 is a side view of a flexographic relief printing plate and fixture demonstrating an embodiment of the present invention.

FIG. 9 is a depiction using a plate cylinder with a flexographic raised relief printing plate mounted using the present invention.

FIG. 10 is a depiction of a flexographic printing press with two ink stations using two plate cylinders and two flexographic raised relief printing plates that were mounted using the present invention.

FIG. 11 is a depiction of a flexographic printing press with two ink stations using two plate cylinders and two flexographic raised relief printing plates that were mounted using the present invention that prints on opposite sides of the receiver.

FIGS. 12a-12c are an embodiment of the present invention using pins for mating features.

FIGS. 13a-13c are an embodiment of the present invention using a reverse line features as the raised relief alignment feature.

FIGS. 14a-14c are an embodiment of the present invention using a long feature as the raised relief alignment feature mating to a long mating alignment feature.

FIGS. 15a-15c are an embodiment of the present invention using a single feature as the raised relief alignment feature.

FIGS. 16a-16c show a top view of a first raised relief printing plate with a first set of raised image features in addition to matching alignment features.

FIGS. 17a-17c show a top view of a second raised relief printing plate with a second set of raised image features in addition to matching alignment features.

FIGS. 18a-18c show a top view of a third raised relief printing plate with a third set of raised image features in addition to matching alignment features.

FIG. 19 is a side view of a first flexographic printing station illustrating a first raised relief printing plate aligned into an alignment fixture with a matching alignment feature.

FIG. 20 is a side view of a first flexographic printing station showing a first raised relief printing plate mounted onto a first plate cylinder using the present invention.

FIG. 21 is a side view of a flexographic printing press with three printing stations and three raised relief printing plates mounted in register onto three plate cylinders using the present invention.

FIG. 22 is an illustration of producing a printed functional receiver using three raised relief printing plates mounted in register using the present invention.

FIG. 23 is a side view of a first stamp printing station showing a first raised relief printing plate mounted onto a first stamp backing plate using the present invention.

FIG. 24 is a side view of a stamp printing press with three printing stations and three raised relief printing plates mounted in register onto three stamp backing plates using the present invention.

FIG. 25 is an illustration of producing a printed functional receiver using three raised relief printing plates as stamps mounted in register using the present invention.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

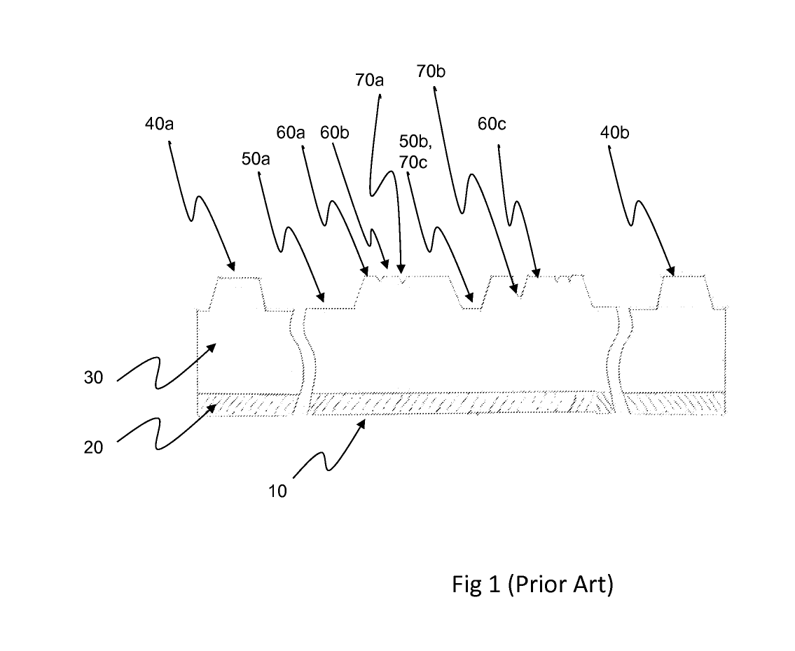

Referring now to FIG. 1 which shows a cross-section of a prior art flexographic printing plate 10 consisting of a support 20 with a flexible raised relief 30. Flexible raised relief 30 consists of a non-printing floor 50a-50b, and a raised image 60a-60c which will be printed. The local relief 70a-70c within the image 60a-60c will vary depending upon the distance between the image features 60a, 60b, and 60c. Raised image 60 may include fiducial marks that are used for aligning the plate to the plate cylinder, or one color plate to another color plate on the print. In addition optional bearer bars 40a-40b may be located in the inked and printed area or outside of the inked and printed area of the plate.

One skilled in the art will recognize that the support 20 may be aluminum, plastic such as polyethylene terepthalate, polycarbonate, poly methyl methacrylate, or a cloth embedded into the flexible raised relief 30. One skilled in the art will recognize that there may be a glue layer (not shown) between the flexible raised relief 30 and the support 20. The flexible raised relief 30 may be molded rubber, ablated rubber, ablated polymer such as poly-butadiene, or a photo cured polymer such as an acrylate mixed with a poly-butadiene-styrene block copolymer. The flexible raised relief 30 may consist of multiple layers.

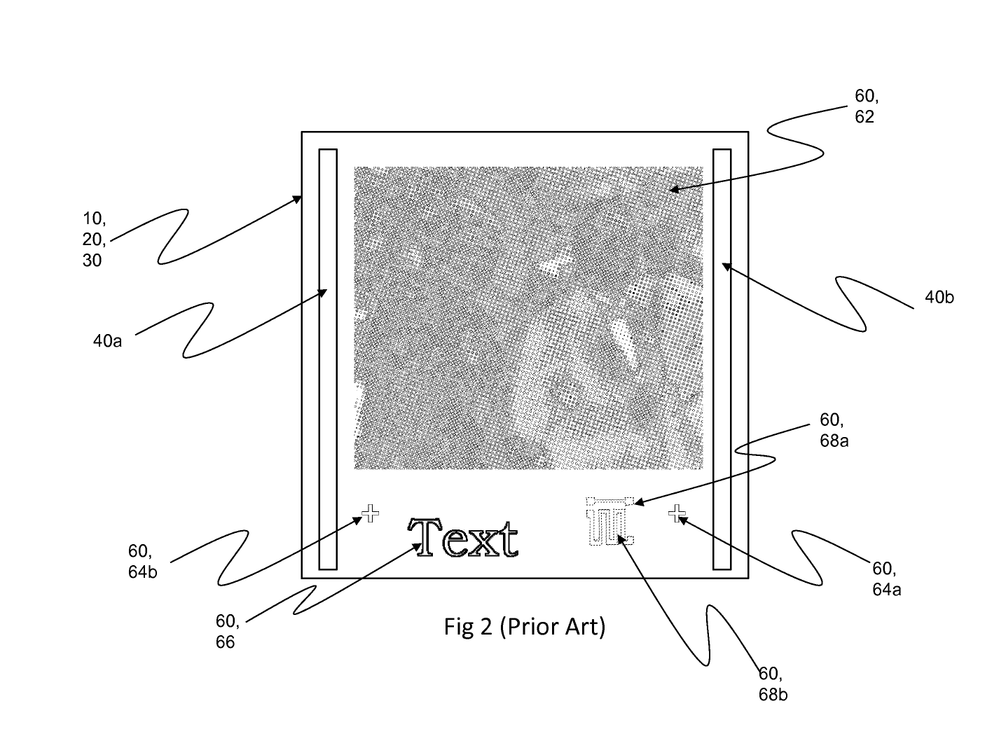

FIG. 2 shows a top view of the prior art flexographic printing plate 10. A typical plate 10, consisting of the support 20 and flexible raised relief 30, will contain an image 60. Image 60 may contain a halftone image 62, fiducial marks 64a-64b for alignment, text 66 or line work, or an imaged functional device such as a conductive trace 68a or an antenna 68b. Optional bearer bars 40a-40b may be inside or outside of the inked area of the plate.

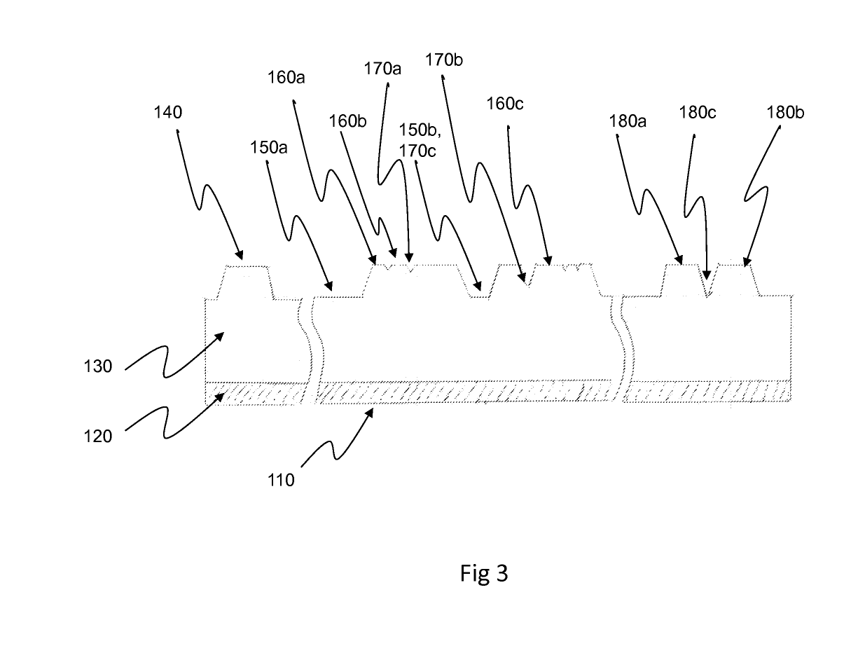

FIG. 3 is a cross-section of an embodiment of the present invention consisting of a flexographic printing plate 110 with a support 120 and a flexible raised relief 130. Flexible raised relief 130 consists of a non-printing floor 150a-150b, and a raised image 160a-160c which will be printed. The local relief 170a-170c within the image 160a-160c will vary depending upon the distance between the raised image features 160a, 160b, and 160c. Raised image 160 may include fiducial marks that are used for aligning the plate to the plate cylinder, or one color plate to another color plate on the print. In addition optional bearer bars 140 may be located in the inked and printed area or outside of the inked and printed area of the plate. Flexible raised relief 130 also contains alignment feature 180 consisting of raised surfaces 180a-180b and a relief surface 180c. Alignment feature 180 may be made out of a reverse line.

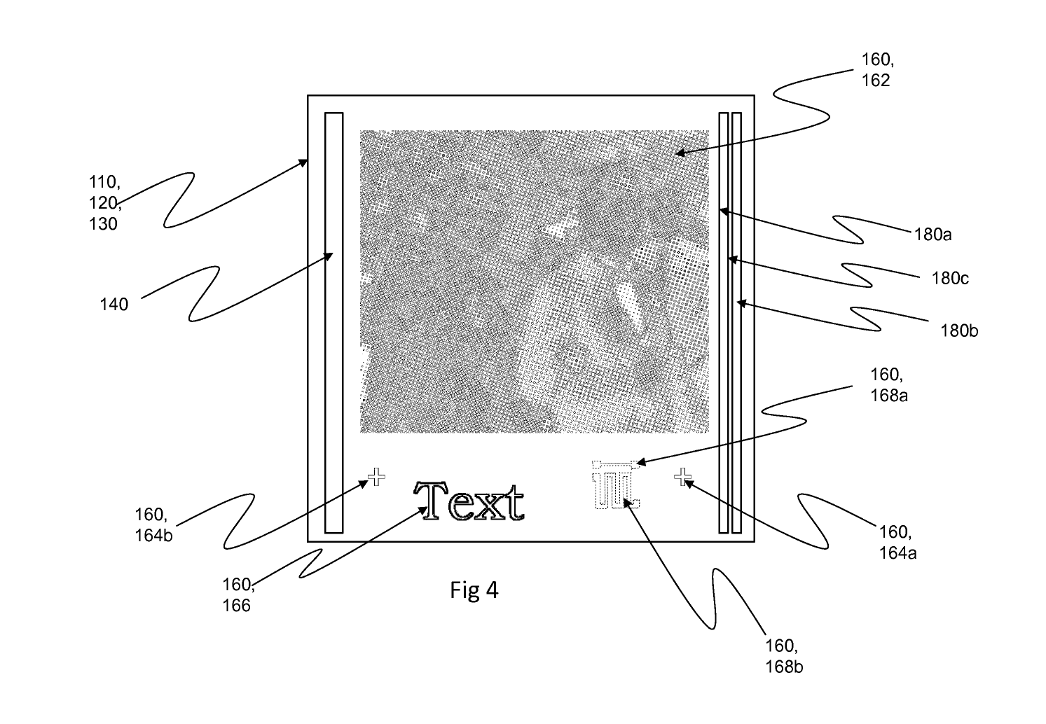

FIG. 4 shows a top view of an embodiment of the present invention consisting of a flexographic printing plate 110. A typical flexographic printing plate 110, consisting of the support 120 and flexible raised relief 130, will contain an image 160. Image 160 may contain a halftone image 162, fiducial marks 164a-164b for alignment, text 166 or line work, or an imaged functional device such as a conductive trace 168a or an antenna 168b. Optional bearer bars 140 may be inside or outside of the inked area of the plate. Flexible raised relief 130 also contains alignment feature 180 consisting of raised surfaces 180a-180b and a relief surface 180c. Alignment feature 180 may be made out of a reverse line.

In an embodiment of the invention alignment feature 180 is a long object outside of the image 160 containing area. In an embodiment of the invention the alignment feature 180 uses a combination of raised surfaces 180a-180b and relief surfaces 180c that will align with matching alignment features in a fixture. Matching alignment features are designed to mate to the alignment features on the plate.

For a photopolymer flexographic printing plate such as Kodak Flexcel NX Plates the depth of the relief surface 180c is controlled by the distance between the raised surfaces 180a, 180b, and the floor exposure used to raise the floor 150a-150b. Typically for a 1.7 mm plate the floor is exposed to a height of 1 mm to 1.2 mm. The local relief for a relief surface 180c with a distance between raised surfaces 180a and 180b will be a depth of 50 to 250 um from the top surface for a 0.5 mm distance between 180a and 180b. Closing the distance between 180a and 180b to 10 um will reduce the relief surface 180c to a depth of 10 um to 20 um from the top surface. The distance between raised surfaces 180a and 180b is easily controlled by ablating a film mask layer in a film writing device (not shown) to within 1 um to 10 um over the full area of the plate. The plate may be as large as 42″×60″. The alignment feature 180 may be as long or wide as the plate. The alignment feature 180 may be along the length or the width of the plate. Two or more alignment features may be used to position the plate in both the X and Y directions.

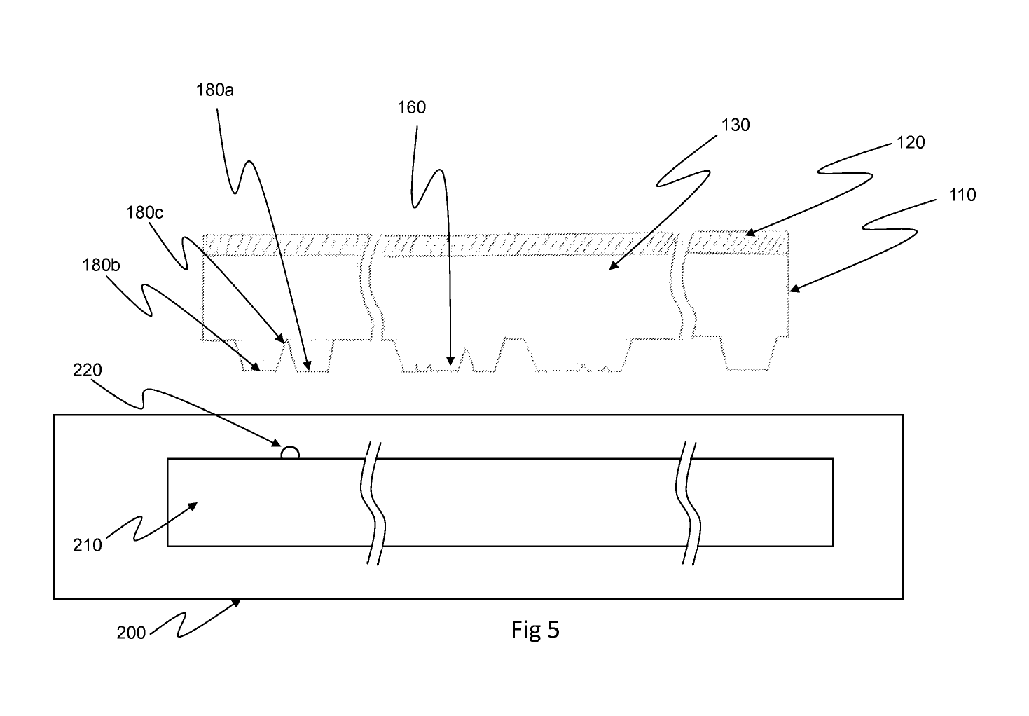

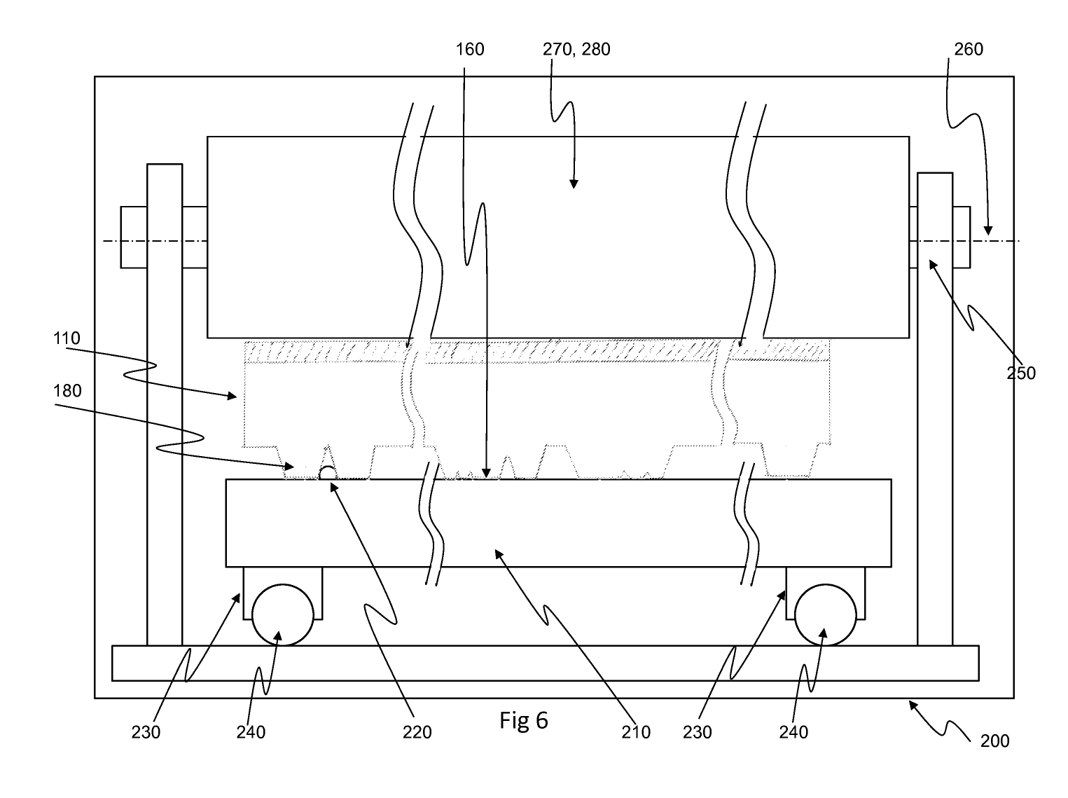

Referring now to FIG. 5 which shows a cross-sectional view of alignment fixture 200 containing moveable platen 210 with matching alignment feature 220 that mates with alignment feature 180 on flexographic printing plate 110. FIG. 6 shows an end view of the invention consisting of the alignment fixture 200, containing the moveable plate 210 with matching alignment feature 220. The moveable platen 210 is mounted on bearing blocks 230 which slide on rails 240. Rails 240 are aligned to the bearings 250 which hold the plate cylinder 270 with mounting tape 280 with the plate cylinder axis 260 exactly perpendicular to the rails 240.

Flexographic printing plate 110 with alignment feature 180 is then placed onto the platen 210 in register with matching alignment feature 220 such that matching alignment feature 220 on platen 210 mates with alignment feature 180 on the flexographic printing plate 110 thereby aligning image features 160 to the alignment fixture 200 and the plate cylinder 270.

In a preferred embodiment the longest axis of the plate is used for alignment feature 180. This long axis is then either parallel or perpendicular to the rails 240 while the plate cylinder axis 260 is perpendicular to the rails 240.

In the embodiment shown in FIG. 6 the alignment feature 180 is parallel to the rails 240 and perpendicular to the plate cylinder axis 260. One skilled in the art will recognize that the alignment feature 180 and matching alignment feature 220 are in the same orientation. One skilled in the art will recognize that alignment feature 180 and matching alignment feature 220 do not need to be parallel nor perpendicular to the plate cylinder axis 260 as long as the set of printing plates that are to be printed while aligned to each other have their corresponding alignment features 180 in the same orientation.

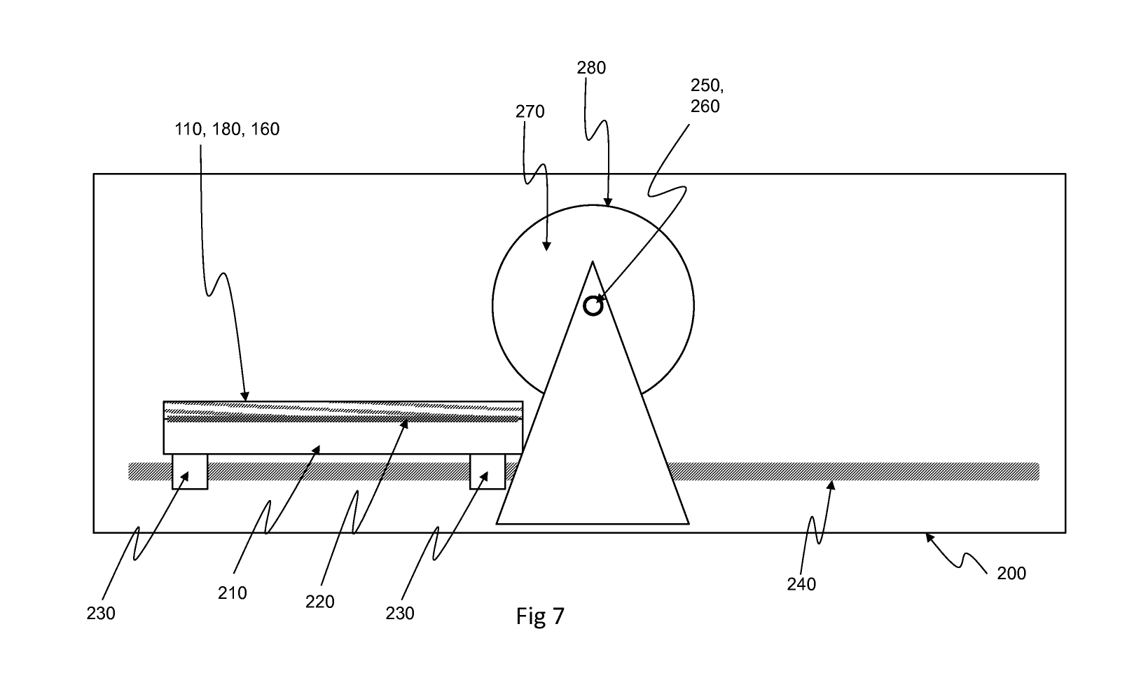

FIG. 7 shows a side view of an embodiment of the present invention. Alignment fixture 200 with the moveable platen 210 mounted on bearing blocks 230 slides on rails 240 to move under the plate cylinder 270. Rails 240 are aligned perpendicular to the plate cylinder axis 260. The plate cylinder 270 is held by bearings 250. Double sided flexographic mounting tape 280 is applied to the surface of the plate cylinder 270. The flexographic printing plate 110 with image features 160 and alignment feature 180 is placed on platen 210 with matching alignment feature 220 mated to alignment feature 180 such that image features on the plate 160 are aligned to the plate cylinder 270.

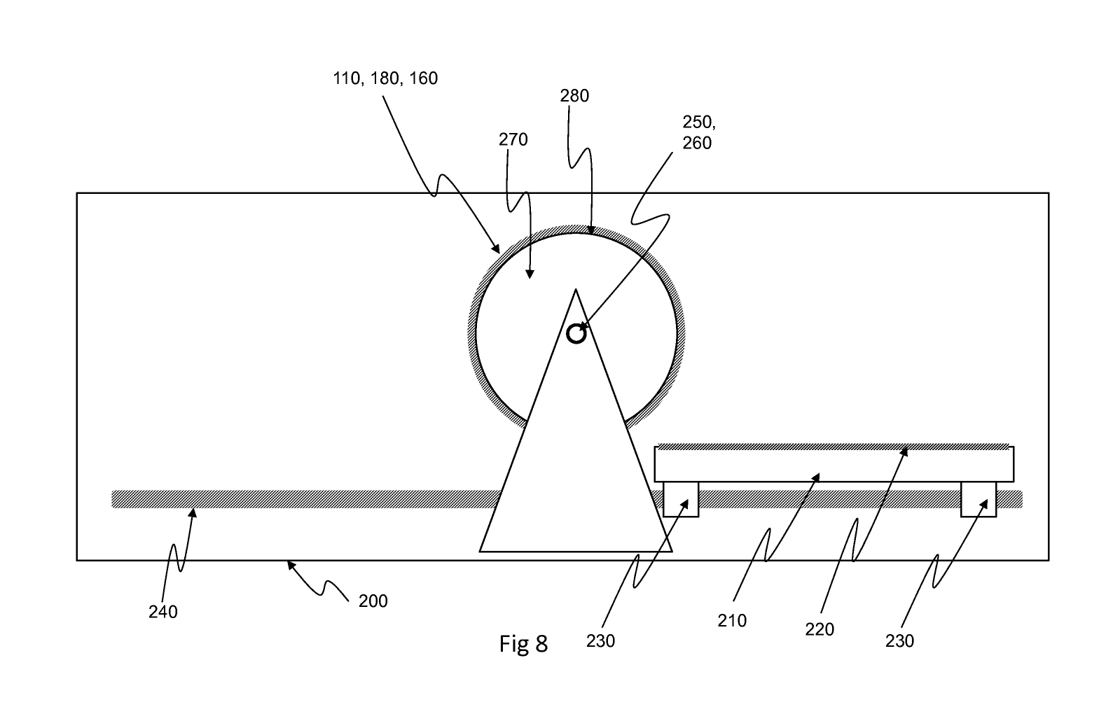

FIG. 8 shows a side view of an embodiment of the present invention where the platen 210 has been translated under the plate cylinder 270 causing plate cylinder 270 to rotate and the flexographic printing plate 110 is picked up onto the double sided tape 280 in register with the plate cylinder 270 thereby mounting the plate onto the plate cylinder.

Once the flexographic printing plate 110 has been mounted in alignment with the plate cylinder 270 the alignment feature 180 may be cut off from the plate.

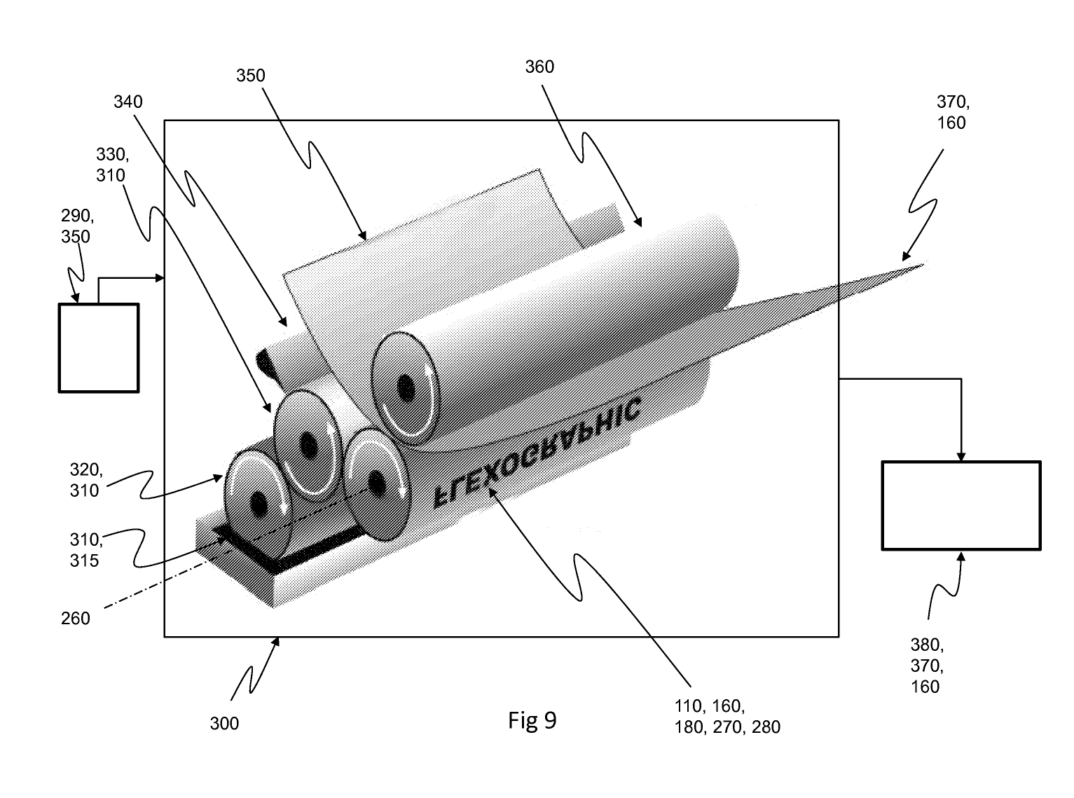

FIG. 9 is an embodiment of the present invention being used in a flexographic printing press ink station 300. A first flexographic printing plate 110 with image 160 and alignment feature 180 is mounted onto the plate cylinder 270 with mounting tape 280. Plate cylinder axis 260 is perpendicular to the support receiver web 350 and aligned to the flexographic printing plate 110 using the present invention. Support receiver web 350 is supplied by supply spool 290. Ink 310 is picked up from ink pan 315 by ink transfer roller 320 and transferred to Anilox roller 330 where it is metered at the knife 340. Metered ink on the anilox roll then coats the raised relief surface of the image 160 on the printing plate 110 which is mounted to the plate cylinder 270. Image 160 is then printed onto the support receiver web 350 which is backed by the impression roller 360 resulting in the printed receiver web 370 with image 160. Printed receiver web 370 with image 160 is then stored in take-up roller 380.

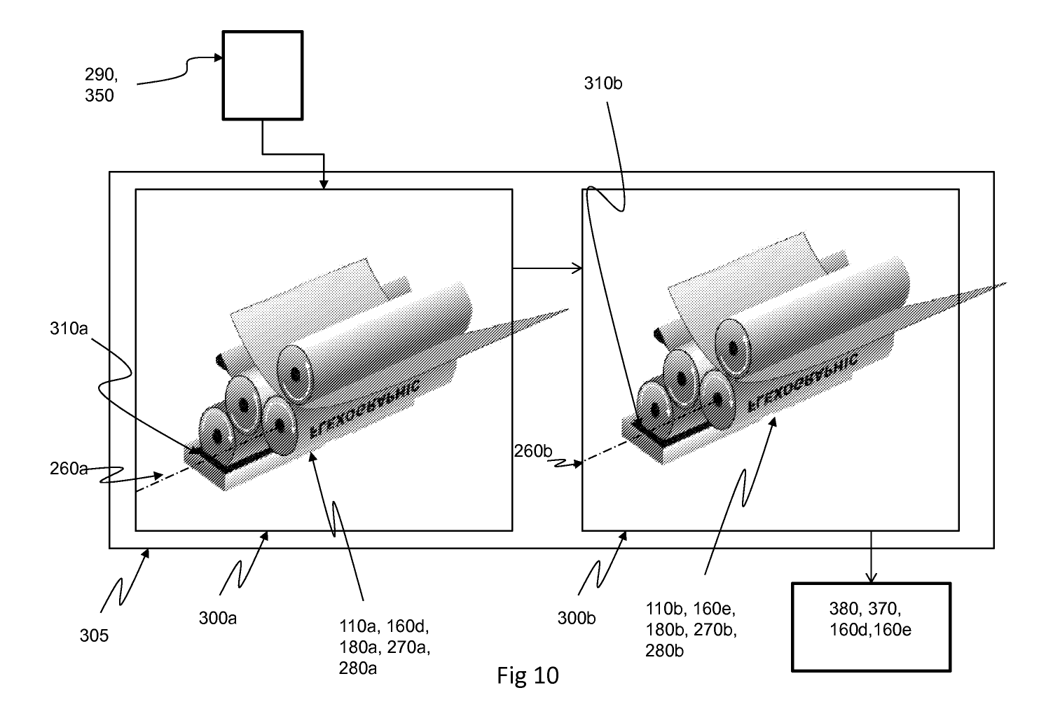

FIG. 10 is an embodiment of the present invention being used in a flexographic printing press 305 with two ink stations 300a and 300b. Flexographic printing plate 110a with a first image 160d and raised surface 180a is mounted onto the first plate cylinder 270a with mounting tape 280a using alignment fixture 200. Plate cylinder axis 260a is perpendicular to the support receiver web 350 and aligned to the flexographic printing plate 110a using the present invention. Support receiver web 350 is supplied by supply spool 290. A first ink 310a is printed using the raised relief surface of the first image 160d on the printing plate 110a which is mounted to the plate cylinder 270a. The first image 160d is then printed onto the support receiver web 350 which is then input to the second ink station 300b. A second flexographic printing plate 110b with a second image 160e and alignment feature 180b is mounted onto the plate cylinder 270b with mounting tape 280b using alignment fixture 200. Plate cylinder axis 260b is perpendicular to the support receiver web 350 and aligned to the flexographic printing plate 110b using the present invention. A second ink 310b is printed using the raised relief surface of the second image 160e on the printing plate 110b which is mounted to the plate cylinder 270b. Second image 160e is then printed onto the support receiver web 350 in register with previously printed first image 160d. Printed receiver web 370 with first and second images 160d and 160e are then stored in take-up roller 380.

Plate cylinder 270b is moved in and out across the web direction to align first image 160d to second image 160e. Plate cylinder 270b is advanced or retarded by rotating relative to the web to align first image 160d to second image 160e in the web direction. Angular alignment between first image 160d to second image 160e is performed by mounting the plates 110a and 110b using the present invention in alignment fixture 200.

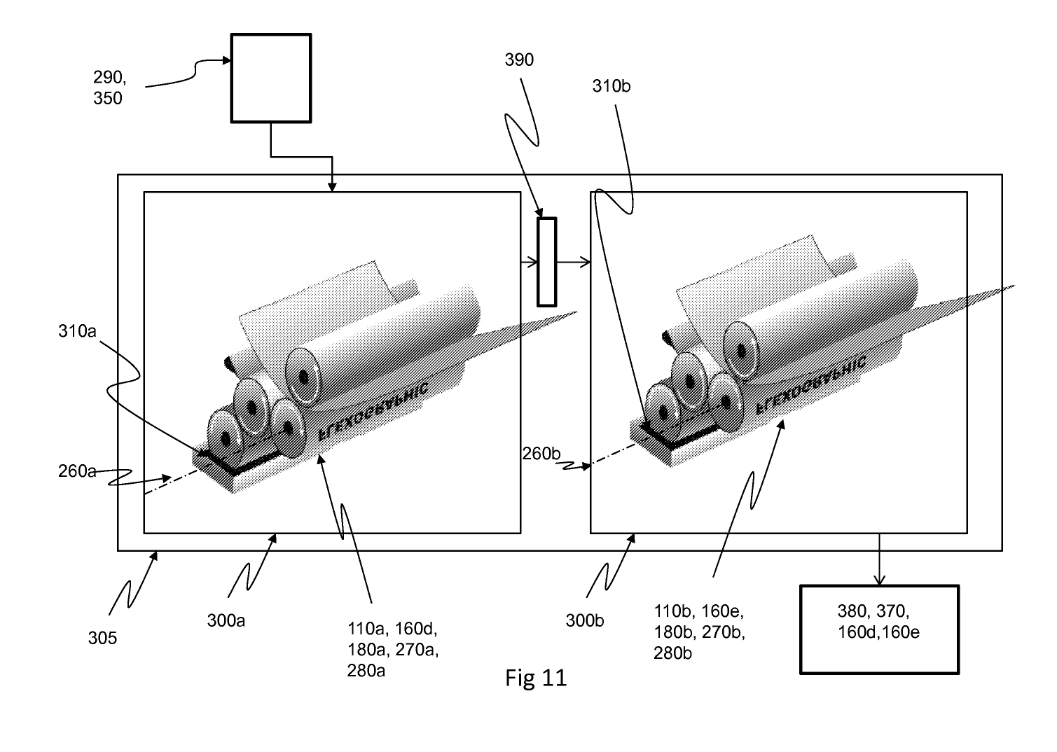

FIG. 11 shows an embodiment of using the present invention with the addition of a web perfecting unit 390 that orientates the web into the second ink station 300b upside down relative to first ink station 300a. A first flexographic printing plate 110a with a first image 160d and alignment feature 180a is mounted onto the plate cylinder 270a with mounting tape 280a using fixture 200. Plate cylinder axis 260a is perpendicular to the support receiver web 350 and aligned to the flexographic printing plate 110a using the present invention. Support receiver web 350 is supplied by supply spool 290. A first ink 310a is printed onto a first side of web 350 using the raised relief surface of the first image 160d on the printing plate 110a which is mounted to the plate cylinder 270a. First image 160d is then printed onto the support receiver web 350 which is then input to the perfecting unit 380. Perfecting unit 380 flips the web upside down on its way into a second ink station 300b. A second flexographic printing plate 110b with a second image 160e and alignment feature 180b is mounted onto the plate cylinder 270b with mounting tape 280b using fixture 200. Plate cylinder axis 260b is perpendicular to the support receiver web 350 and aligned to the flexographic printing plate 110b using the present invention. Second ink station 310b then prints using the raised relief surface of the second image 160e onto the back side in register to the first image 160a on the front side. Printed receiver web 370 with first and second images 160d and 160e are then stored in take-up roller 380.

Plate cylinder 270b is moved in and out across the web direction to align the second image 160e to the first image 160d. Plate cylinder 270b is advanced or retarded by rotating relative to the web to align the second image 160e to the first image 160d in the web direction. Angular alignment between the second image 160e to the first image 160d is performed by mounting the plates 110a and 110b using the present invention.

One skilled in the art will recognize that plate cylinders, impression cylinders and web tension may be driven by servo motors to enable reducing the engagement between the plate cylinder and the web in order to print smaller features.

One skilled in the art will recognize that the image 160 may contain halftone images, solid colored artwork, line work, text, conductive traces, insulating areas, semiconductive areas, and doped areas. One skilled in the art will recognize that the image 160 may contain a structure that is printed as a part of a three-dimensional object. Image 160 may also be printed with an ink that is dissolved, etched, plasma etched, or evaporated to later create a void within a three-dimensional object. Image 160 may also be printed with an ink that is dried, optically cured, vapor cured, or heat cured, to become a remaining structure of a three-dimensional object.

The receiver web 350 may be paper, plastic, metal, film, metalized film, or flexible glass. The receiver web may be coated. Coatings may include receptive layers to promote adhesion, plastics, plasma coatings, plasma coated semiconductors, plasma coated metals, moisture blocking layers, insulating layers, polymer layers, and glass layers. The receiver web may be preprinted.

One skilled in the art will recognize that the invention is applicable to flexographic printing of multiple color planes, electronic devices, and functional printing that requires multiple inks in registration to each other The printed receiver web 370 may be a functional printed device. Functional printing may be used for electronic devices where one prints conductive inks, insulating inks, and semiconducting inks in addition to colored inks Functional printing may be used for mechanical devices where one prints structural inks and forms 3D devices. Functional printing may be used for making light emitting or light detecting devices where one prints organic light emitting diodes or photo responsive diode junctions. Functional printing may be used for making electronic devices useful for measuring strain, stress, and temperature. Functional printing may be used for making capacitive devices that are used to measure touch or detect proximity of objects. All of these devices require registration of multiple layers which are printed with individual inks.

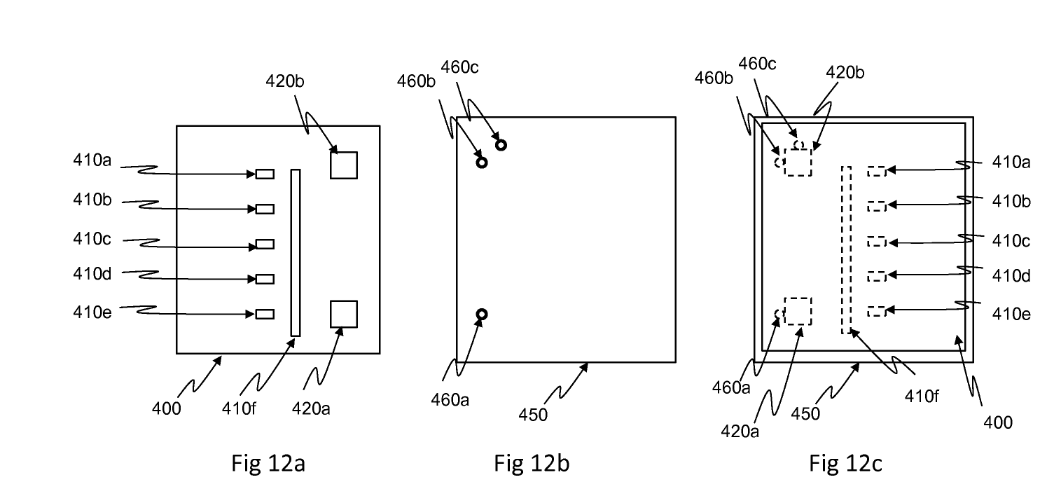

Referring now to FIG. 12a which shows a top view of a raised relief printing plate 400 consisting of a set of first raised image features 410a-410f and raised relief alignment features 420a and 420b. Image features may contain an array of features such as raised relief image features 410a-410e. FIG. 12b shows a top view of an alignment fixture 450 with matching alignment features 460a, 460b, and 460c, where matching alignment features 460a-460c are pins that will mate to edges of raised alignment features 420a and 420b. FIG. 12c shows a top view of the raised relief printing plate 400 upside down and mounted in the alignment fixture 450 with raised alignment feature 420b constrained by matching alignment features 460b and 460c while raised alignment feature 420a is constrained by matching alignment feature 460a. This aligns raised image features 410a-410f to alignment fixture 450.

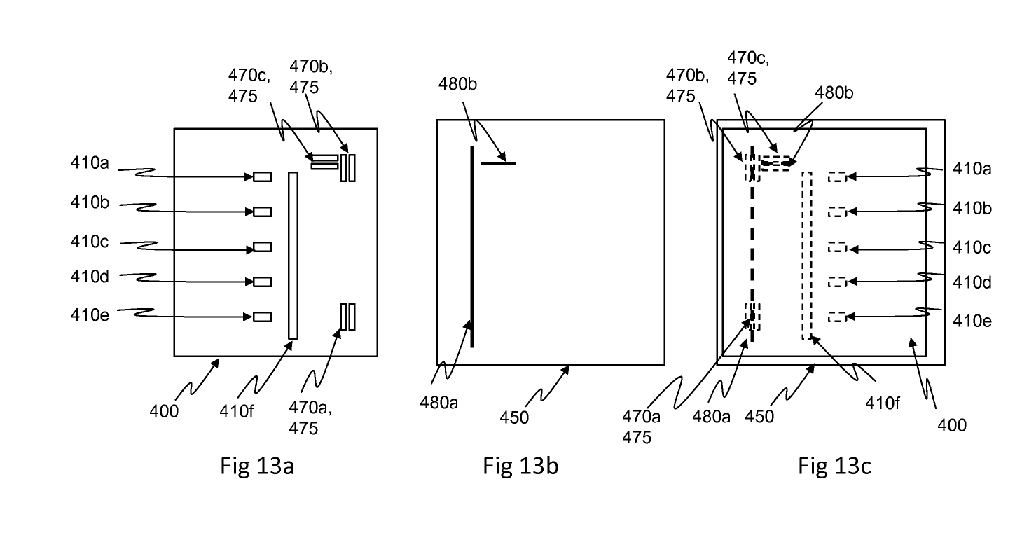

Referring now to FIG. 13a which shows a top view of a raised relief printing plate 400 consisting of a set of first raised image features 410a-410f and raised relief alignment features 470a, 470b, and 470c. Raised relief alignment features 470a-470c are also known as reverse lines 475. FIG. 13b shows a top view of an alignment fixture 450 with matching alignment features 480a and 480b. Matching alignment features 480a and 480b are lines or wires that will mate to edges of groves caused by raised relief alignment features 470a-470c which are composed of reverse lines 475. FIG. 13c shows a top view of the raised relief printing plate 400 upside down and mounted in the alignment fixture 450 with raised relief alignment features 470a and 470b constrained by matching alignment feature 480a while raised relief alignment feature 470c is constrained by matching alignment feature 480b. This aligns raised image features 410a-410f to alignment fixture 450.

Lines or wires mating to reverse lines or reverse edges in the flexible relief is more preferred over aligning pins to edges due to the flexible nature of the raised relief plate. A normal kinematic mount would prefer to use pins to limit the contact area to a single well defined point. Point loads in a flexible relief create a deformation leading to a less well defined position of the plate. Reverse lines in the flexible relief are more preferred to edges as the wire or line in the mating surface pushes equally into the reverse line loading the plate equally on all sides and resulting in a consistent plate position. One may tune this position slightly by making the solid feature of the reverse line thicker on one side or the other thereby biasing the plate to one side by making one side of the reverse line on the plate stiffer than the other. All of the raised features on the plate are created at the same time and in register to each other.

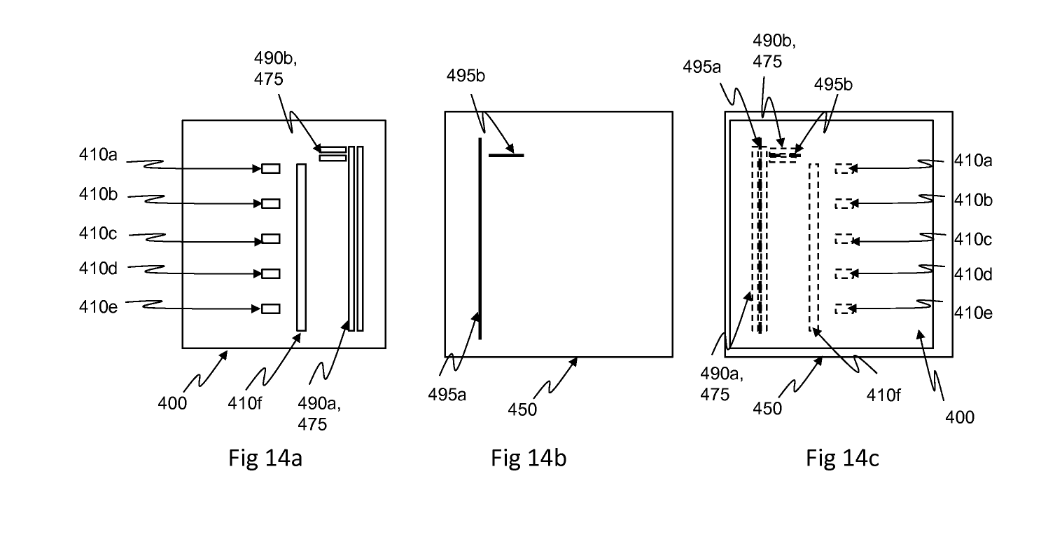

Referring now to FIG. 14a which shows a top view of a raised relief printing plate 400 consisting of a set of first raised image features 410a-f and raised relief alignment features 490a and 470b. Raised relief alignment features 490a-b are also known as reverse lines 475. FIG. 14b shows a top view of an alignment fixture 450 with matching alignment features 495a and 495b. Matching alignment features 495a and 495b are lines or wires that will mate to edges of groves caused by raised relief alignment features 490a-490b which are composed of reverse lines 475. FIG. 14c shows a top view of the raised relief printing plate 400 upside down and mounted in the alignment fixture 450 with raised relief alignment features 490a constrained by matching alignment feature 495a while raised relief alignment feature 490b is constrained by matching alignment feature 495b. This aligns raised image features 410a-410f to alignment fixture 450.

FIGS. 14a-14c shows the most preferred embodiment of the invention using a long raised relief alignment feature 490a mating to a long matching alignment feature 495a. This is the opposite of the traditional kinetic method of using two pins to exactly constrain a straight edge. On an edge composed of a flexible surface two pins would deform the edge at the points of contact resulting in the position of the flexible surface being dependent upon the deformation.

One skilled in the art will recognize that the second raised relief alignment feature 490b in a second direction from a first raised relief alignment feature 490a may also be a long raised relief alignment feature.

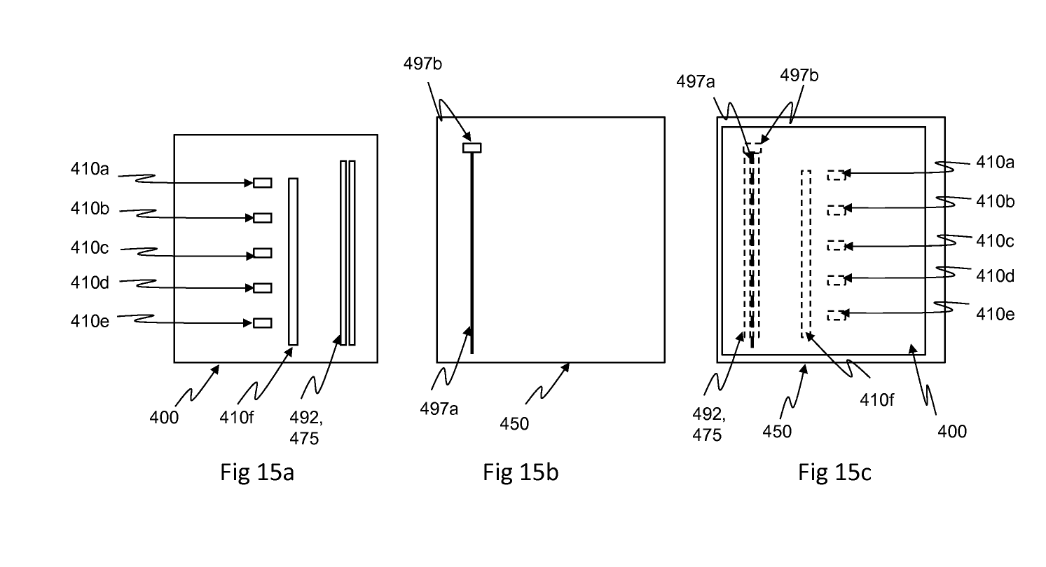

Referring now to FIG. 15a which shows a top view of a raised relief printing plate 400 consisting of a set of first raised image features 410a-410f and raised relief alignment feature 492. Raised relief alignment features 492 is also known as reverse lines 475. FIG. 15b shows a top view of an alignment fixture 450 with matching alignment features 497a and 497b. Matching alignment feature 497a is a line or wire that will mate to edges of groves of raised relief alignment features 492 which is composed of reverse lines 475. Matching alignment feature 497b is a solid surface or line that will mate to an edge of raised relief alignment feature 492. FIG. 15c shows a top view of the raised relief printing plate 400 upside down and mounted in the alignment fixture 450 with raised relief alignment feature 492 constrained by matching alignment feature 497a while raised relief alignment feature 492 is constrained by matching alignment feature 497b in a second direction. This aligns raised image features 410a-410f to alignment fixture 450.

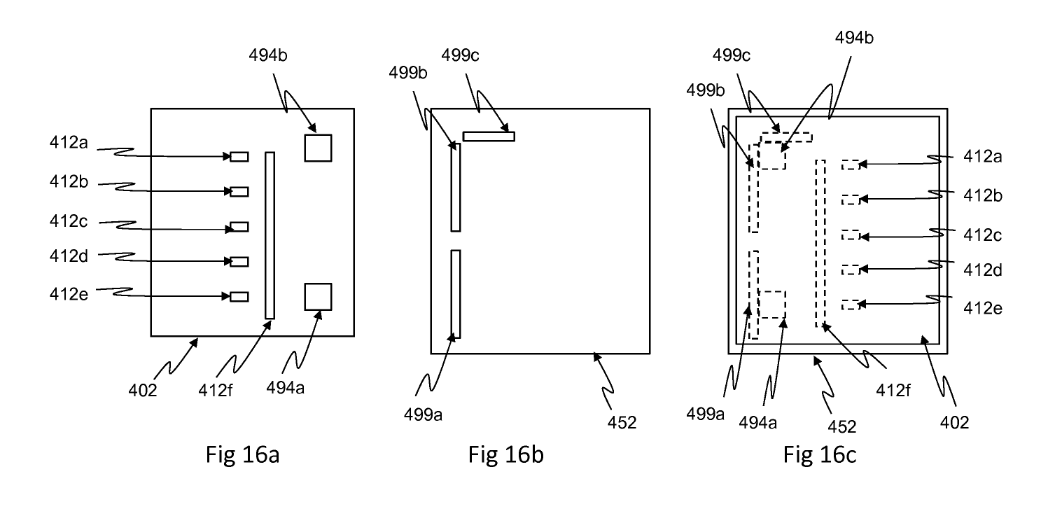

Referring now to FIG. 16a showing a top view of a first raised relief printing plate 402 consisting of a first set of raised image features 412a-412f and a first set of raised relief alignment features 494a and 494b. FIG. 16b shows a top view of an alignment fixture 452 with matching alignment features 499a-499c. FIG. 16c shows a top view of the first raised relief printing plate 402 upside down and mounted in the alignment fixture 452. Raised relief alignment feature 494a is constrained by matching alignment feature 499a in a first direction. Raised relief alignment feature 494b is constrained by matching alignment feature 499b in a first direction. Raised relief alignment feature 494b is also constrained by matching alignment feature 499c in a second direction. This aligns raised image features 412a-412f to alignment fixture 452.

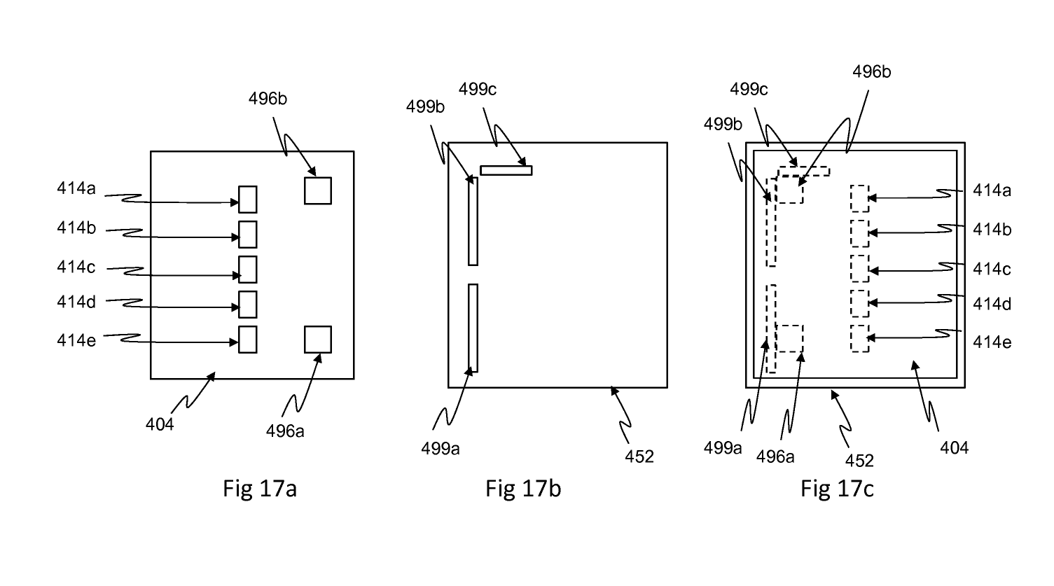

Referring now to FIG. 17a which shows a top view of a second raised relief printing plate 404 consisting of a second set of raised image features 414a-414e and a second set of raised relief alignment features 496a and 496b. FIG. 17b shows a top view of alignment fixture 452 with matching alignment features 499a-499c. FIG. 17c shows a top view of the second raised relief printing plate 404 upside down and mounted in the alignment fixture 452. Raised relief alignment feature 496a is constrained by matching alignment feature 499a in a first direction. Raised relief alignment feature 496b is constrained by matching alignment feature 499b in a first direction. Raised relief alignment feature 496b is also constrained by matching alignment feature 499c in a second direction. This aligns raised image features 414a-414e to alignment fixture 452.

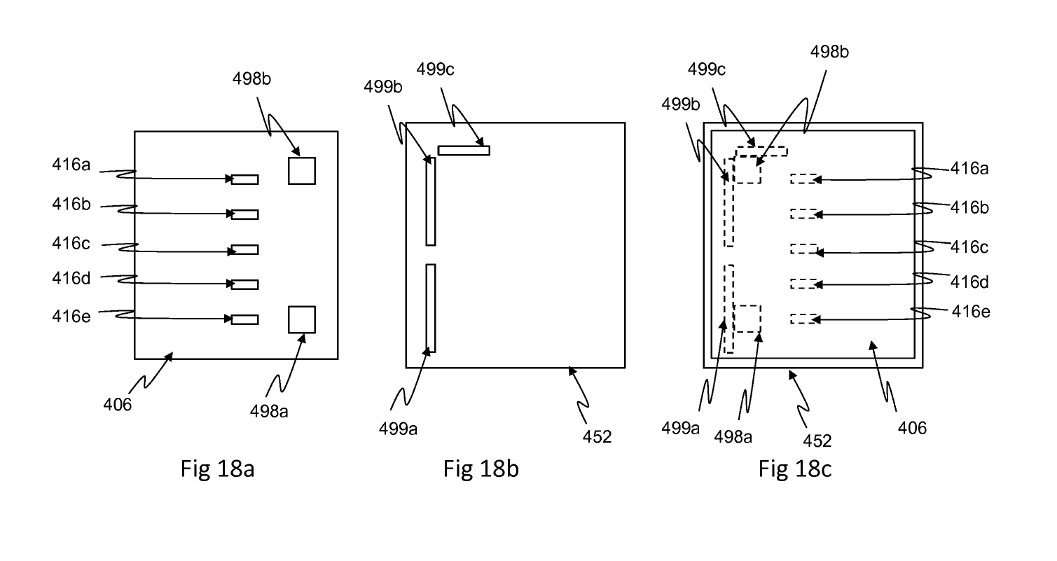

Referring now to FIG. 18a which shows a top view of a third raised relief printing plate 406 consisting of a third set of raised image features 416a-416e and a third set of raised relief alignment features 498a and 498b. FIG. 18b shows a top view of alignment fixture 452 with matching alignment features 499a-499c. FIG. 18c shows a top view of the second raised relief printing plate 406 upside down and mounted in the alignment fixture 452. Raised relief alignment feature 498a is constrained by matching alignment feature 499a in a first direction. Raised relief alignment feature 498b is constrained by matching alignment feature 499b in a first direction. Raised relief alignment feature 498b is also constrained by matching alignment feature 499c in a second direction. This aligns raised image features 416a-416e to alignment fixture 452.

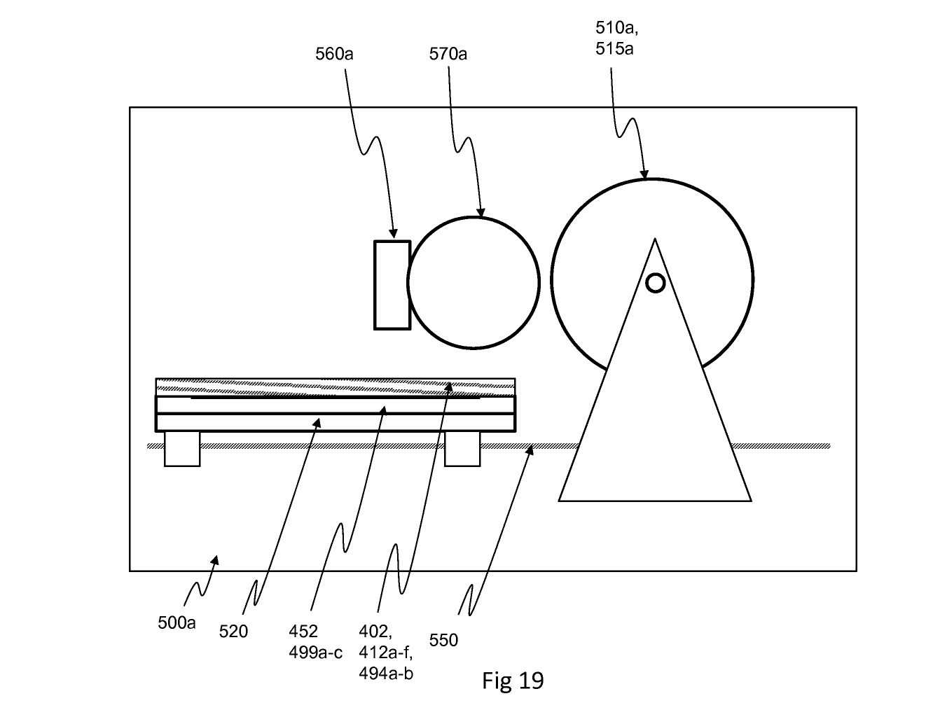

FIG. 19 is a side view of a first flexographic printing station 500a with a first plate cylinder 510a that will print onto receiver held on platen 520. First plate cylinder 510a has flexographic mounting tape 515a installed on its surface. Platen 520 has alignment fixture 452 with matching alignment features 499a-499c installed on the platen surface. A first raised relief printing plate 402 with a first set of raised relief image features 412a-412f and a first set of raised relief alignment features 494a and 494b is upside down and mounted in the alignment fixture 452 such that the matching alignment features 499a-499c are mated to the first set of raised relief alignment features 494a and 494b and the first set of raised relief image features 412a-412f are aligned to alignment fixture 452 and thereby the platen 520, platen rails 550, and the first plate cylinder 510a.

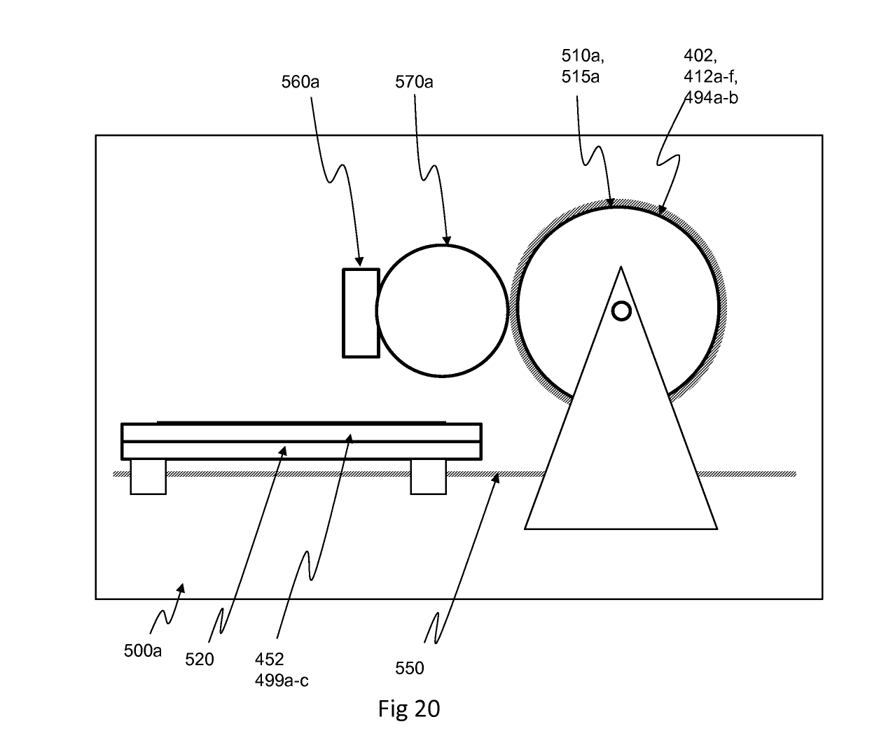

FIG. 20 shows a side view of the first flexographic printing station 500a with the first plate cylinder 510a that prints onto a receiver that will be held with platen 520. Platen 520 moves on platen rails 550 which are aligned to the first plate cylinder 510a. First plate cylinder 510a has flexographic mounting tape 515a installed on its surface. First plate cylinder 510a also has the first raised relief printing plate 402 installed on top of the mounting tape 515a by sliding the platen 520 along the platen rails 550 while engaging the plate cylinder 510a with mounting tape 515a to the back of the first raised relief printing plate 402 with image features 412a-412f and first set of raised relief alignment features 494a and 494b. First raised relief printing plate 402 is now installed onto first plate cylinder 510a in register to the first plate cylinder 510a and the platen 520 using the present invention.

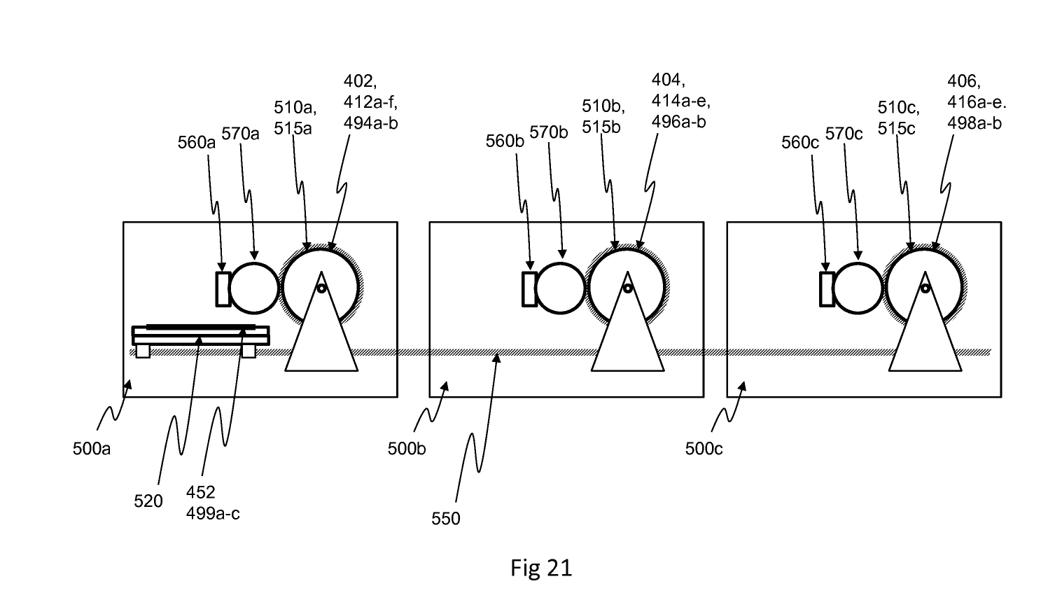

FIG. 21 shows a side view of a first 500a, second 500b, and third 500c flexographic printing stations that will print onto a receiver that will be held by platen 520 that slides along platen rails 550. Platen 520 has alignment fixture 452 with matching alignment features 499a-499c installed on the platen surface. Alignment fixture 452 is mated to the first raised relief printing plate 402 with image features 412a-412f and first set of raised relief alignment features 494a and 494b which are used to transfer the first raised relief printing plate 402 to the first plate cylinder 510a with its mounting tape 515a in register to the platen 520. Alignment fixture 452 is then mated to the second raised relief printing plate 404 with image features 414a-414e and second set of raised relief alignment features 496a and 496b which are used to transfer the second raised relief printing plate 404 to the second plate cylinder 510b with its mounting tape 515b in register to the platen 520. Alignment fixture 452 is then mated to the third raised relief printing plate 406 with image features 416a-416e and third set of raised relief alignment features 498a and 498b which are used to transfer the third raised relief printing plate 406 to the third plate cylinder 510c with its mounting tape 515c in register to the platen 520. All three printing plates have now been aligned to the common platen 520 using the present invention.

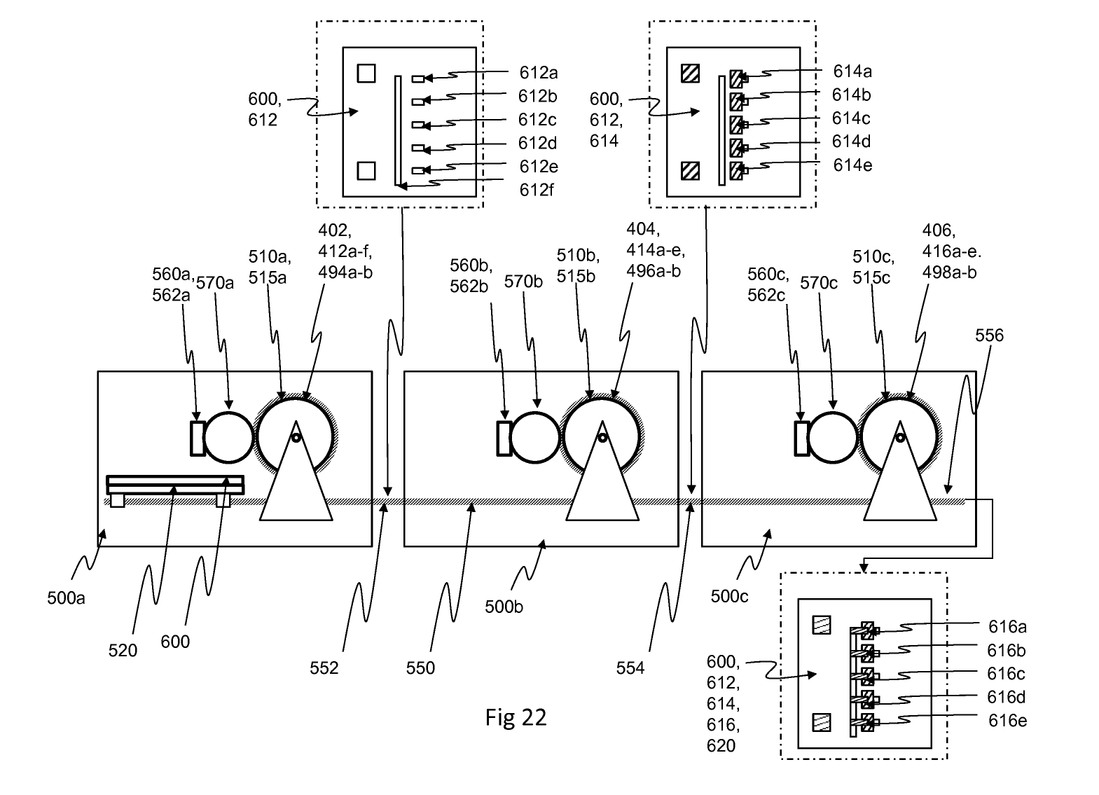

FIG. 22 shows a side view of the first 500a, second 500b, and third 500c flexographic printing stations that will print onto a receiver 600 that will be held by platen 520 that slides along platen rails 550.

First raised relief printing plate 402 on first cylinder 510a is inked by gravure cylinder 570a and chambered doctor blade 560a with a first ink 562a. Platen 520 with receiver 600 slides along rails from left to right to position 552. As the platen translates under first plate cylinder 510a, the first ink 562a is transferred from first raised relief printing plate 402 in the pattern of the first set of raised relief image features 412a-412f producing a first printed image 612 onto the receiver 600 with first set of printed image features 612a-612f.

Second raised relief printing plate 404 on second cylinder 510b is inked by gravure cylinder 570b and chambered doctor blade 560b with a second ink 562b. Platen 520 with receiver 600 slides along rails from left to right from position 552 to position 554. As the platen translates under the second plate cylinder 510b, the second ink 562b is transferred from the second raised relief printing plate 404 in the pattern of the second set of raised relief image features 414a-414e producing a second printed image 614 onto the receiver 600 with second set of printed image features 614a-614e aligned to first set of printed image features 612a-612f.

Third raised relief printing plate 406 on third cylinder 510c is inked by gravure cylinder 570c and chambered doctor blade 560c with a third ink 562c. Platen 520 with receiver 600 slides along rails from left to right from position 554 to position 556. As the platen translates under the third plate cylinder 510c, the third ink 562c is transferred from third raised relief printing plate 406 in the pattern of the third set of raised relief image features 416a-416e producing a third printed image 616 onto the receiver 600 with a third set of printed image features 616a-616e aligned to the first set of printed image features 612a-612f and the second set of printed image features 614a-614e resulting in a printed functional receiver 620.

Printed functional receiver 620 may be an electronic device, a memory device, a multi-colored graphic image, a conductive device, a light emitting device, a light detecting device, a strain or stress detecting device, or a mechanical electronic device.

Receiver 600 may be plastic, paper, metal, silicon, a semiconductor, film, metalized film, coated film, ceramic, or glass. Receiver 600 may be rough or smooth. Receiver 600 may have different heights within the range of the relief on the raised relief printing plates.

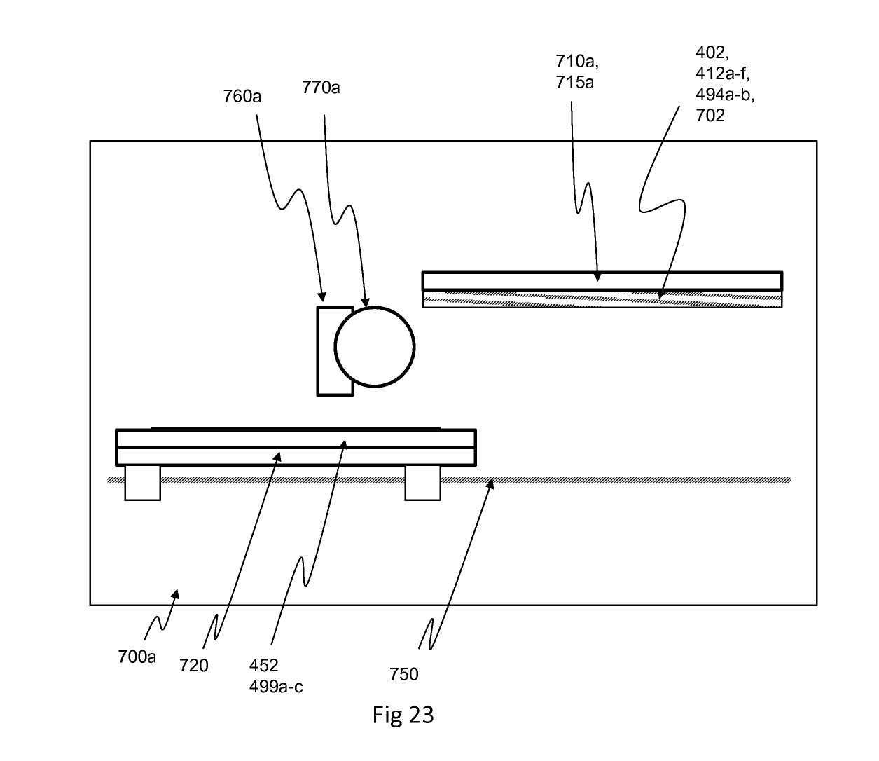

Referring to FIG. 23, the present invention may be used to mount a first raised relief printing plate 402 to be used as a first stamp 702 in register to a platen 720 and other stamps (not shown). A first stamp printing station 700a with a platen 720 is fitted with the alignment fixture 452 with matching alignment features 499a-499c. Alignment fixture 452 is mated to the first raised relief printing plate 402 with image features 412a-412f and a first set of raised relief alignment features 494a and 494b by mating first set of raised relief alignment features 494a and 494b to matching alignment features 499a-499c. This aligns image features 412a-412f to the platen 720. The platen 720 is then moved along platen rails 750 in register under the stamp backing plate 710a with its mounting tape 715a. The stamp backing plate 710 a is moved down to pick up the first raised relief printing plate 402. The stamp backing plate 710a is then raised and the first raised relief printing plate 402 is transferred to the first stamp backing plate 710a to become stamp 702 which is mounted in register to the platen 720.

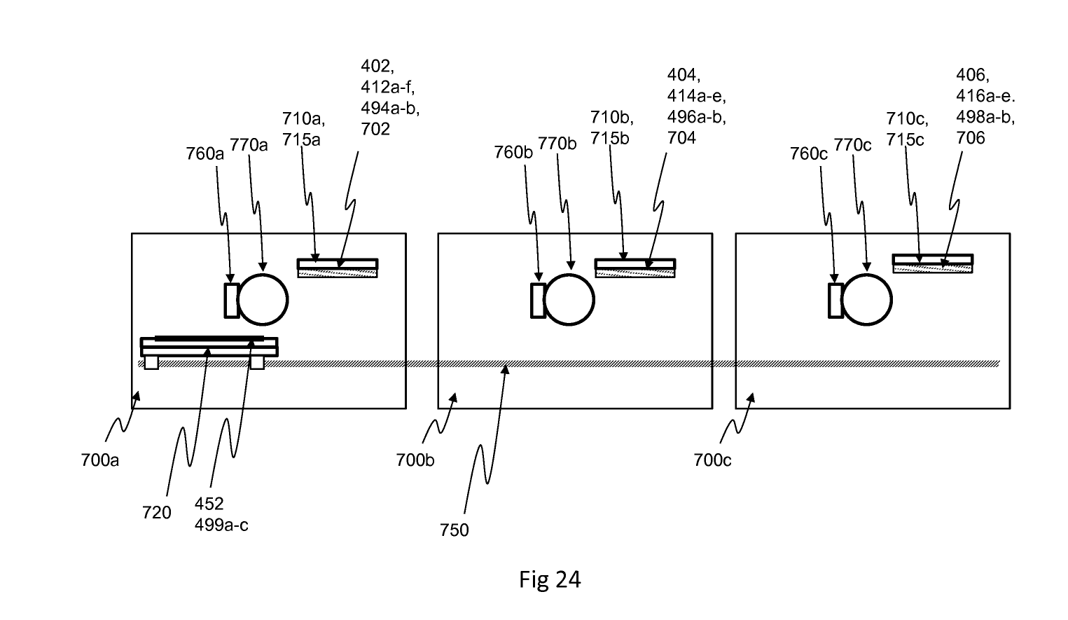

Referring to FIG. 24, the present invention may be used to mount a set of raised relief printing plates, 402, 404, and 406 to be used as stamps 702, 704, and 706 respectively; all in register to a platen 720.

FIG. 24 shows a side view of a first 700a, second 700b, and third 700c stamp printing stations that will print onto a receiver that will be held by platen 720 that slides along platen rails 750. Platen 720 has alignment fixture 452 with matching alignment features 499a-499c installed on the platen surface. Alignment fixture 452 is mated to the first raised relief printing plate 402 with a first set of raised relief image features 412a-412f and a first set of raised relief alignment features 494a and 494b and used to transfer the first raised relief printing plate 402 to the first stamp backing plate 710a with its mounting tape 715a to become a first stamp 702 in register to the platen 720. Alignment fixture 452 is then mated to the second raised relief printing plate 404 with a second set of raised relief image features 414a-414e and second set of raised relief alignment features 496a and 496b and used to transfer the second raised relief printing plate 404 to the second stamp backing plate 710b with its mounting tape 715b to become a second stamp 704 in register to the platen 720. Alignment fixture 452 is then mated to the third raised relief printing plate 406 with a third set of raised relief image features 416a-416e and a third set of raised relief alignment features 498a and 498b and used to transfer the third raised relief printing plate 406 to the third stamp backing plate 710c with its mounting tape 715c to become a third stamp 706 in register to the platen 720. All three printing plates 402, 404, and 406 have now been installed as stamps 702, 704, and 706, aligned to the common platen 720 using the present invention.

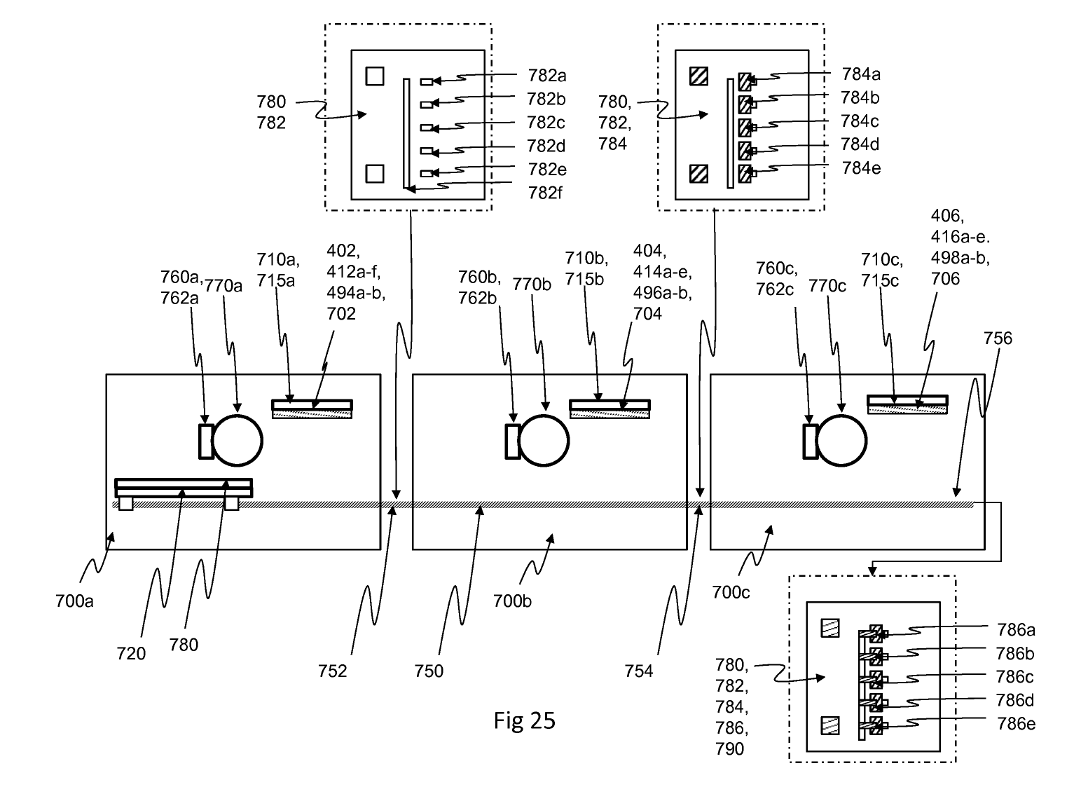

FIG. 25 shows a side view of the first 700a, second 700b, and third 700c stamp printing stations that will print onto a receiver 780 that is held by platen 720 that slides along platen rails 750.

First stamp 702 on first stamp backing plate 710a is inked by gravure cylinder 770a and chambered doctor blade 760a with a first ink 762a. Platen 720 with receiver 780 slides along rails from left to right to position 752. As the platen is under first stamp 702, stamp 702 is moved down to transfer the first ink 762a from first raised relief printing plate 402 in the pattern of the first set of raised relief image features 412a-412f producing a first printed image 782 onto the receiver 780 with first set of printed image features 782a-782f. Stamp 702 is then moved back up and the platen is translated to platen position 752.

Second stamp 704 on second stamp backing plate 710b is inked by gravure cylinder 770b and chambered doctor blade 760b with a second ink 762b. Platen 720 with receiver 780 slides along rails from left to right from position 752 to a fixed position under the second stamp 704. The second stamp 704 is moved down to transfer ink from second raised relief printing plate 404 in the pattern of the second set of raised relief image features 414a-414e producing a second printed image 784 onto the receiver 780 with second set of printed image features 784a-784e aligned to first set of printed image features 782a-782f. The second stamp 704 is then raised and the platen is moved to platen position 754.

Third stamp 706 on third stamp backing plate 710c is inked by gravure cylinder 770c and chambered doctor blade 760c with a third ink 762c. Platen 720 with receiver 780 slides along rails from left to right from position 754 to a fixed position under the third stamp 704. The third stamp 704 is moved down to transfer the third ink 762c from third raised relief printing plate 404 in the pattern of the third set of raised relief image features 416a-416e producing a third printed image 786 onto the receiver 780 with third set of printed image features 786a-786e aligned to the second set of printed image features 784a-784e and the first set of printed image features 782a-782f. The third stamp 706 is then raised and the platen is moved to platen position 756 resulting in a printed functional receiver 790.

A flexographic plate is a raised relief printing plate that prints by applying ink to the raised relief on the plate, and transferring the ink to a receiver. A flexographic plate is otherwise known as a relief plate, or as a raised relief plate. Other types of raised relief plates include pad printing stamps, stamps, and rubber stamps, wood blocks, and metal type. Raised relief plates may contain rubber, butadiene, block copolymers such as butadiene-styrene block copolymer. Plates may be carved by hand, molded, etched, ablated by laser, or photographically processed to create the raised relief pattern that is printed.

One skilled in the art will recognize that the invention may be used for aligning plate cylinders or flat stamps. The invention may be used to print to receivers consisting of a web, cut sheets, or independent devices such as cans, plates, bottles, silicon wafers, liquid crystal displays, cell phones, television screens, monitor screens, touch screen displays and appliances such as refrigerators, stoves, ovens, sinks, automotive dashboards, and printed circuit boards.

It is an advantage of the present invention that an optical measurement is not required for mounting and aligning a raised relief flexographic printing plate to a plate cylinder.

It is an advantage of the present invention that it uses the raised printed surface to create the raised relief alignment feature that mates with the mating feature of the fixture.

It is an advantage of the present invention that a long edge or surface of the flexible raised relief is used to align the plate. Use of kinematic methods, exact constraint, or a pin to provide location to a point causes the flexible plate relief surface to compress and introduce errors in the alignment while use of an edge or the naturally occurring V-groove of an inverse line pattern provides numerous flexible surfaces to obtain a repeatable mounted position.

It is an advantage of the present invention to use an inverse line V-groove pattern and deform the plate symmetrically while mounting to the mating alignment feature.

The invention has been described in detail with particular reference to certain preferred embodiments thereof, but it will be understood that variations and modifications can be effected within the scope of the invention.

### PARTS LIST

10 flexographic printing plate
20 support
30 raised relief
40a bearer bar
40b bearer bar
50a floor
50b floor
60 image
60a image
60b image
60c image
62 halftone image
64a fiducial mark
64b fiducial mark
66 text
68a conductive trace
68b antennae
70a local relief
70b local relief
70c local relief
110 flexographic printing plate
110a flexographic printing plate
110b flexographic printing plate
120 support
130 raised relief
140 bearer bar
150a floor
150b floor
160 image
160a image
160b image
160c image
160d first image
160e second image
162 halftone image
164a fiducial mark
164b fiducial mark
166 text
168a conductive trace
168b antennae
170a local relief
170b local relief
170c local relief
180 alignment feature
180a raised surface
180b raised surface
180c relief surface
200 alignment fixture
210 moveable platen
220 matching alignment feature
230 bearing block
240 rails
250 bearings
260 plate cylinder axis
260a plate cylinder axis
270 plate cylinder
270a plate cylinder
270b plate cylinder
280 mounting tape
280a mounting tape
280b mounting tape
290 supply spool
300 ink station
300a ink station
300b ink station
305 flexographic printing press
310 ink
310a first ink
310b second ink
315 ink pan
320 transfer roller
330 anilox roller
340 knife
350 receiver web
360 impression roller
370 printed receiver web
380 take-up roller
390 web perfecting unit
400 raised relief printing plate
402 first raised relief printing plate
404 second raised relief printing plate
406 third raised relief printing plate
410a-f raised relief image features
412a-f first set of raised relief image features
414a-e second set of raised relief image features
416a-e third set of raised relief image features
420a raised relief alignment feature
420b raised relief alignment feature
450 alignment fixture
452 alignment fixture
460a matching alignment feature
460b matching alignment feature
460c matching alignment feature
470a raised relief alignment feature
470b raised relief alignment feature
470c raised relief alignment feature
475 reverse line
480a matching alignment feature
480b matching alignment feature
490a raised relief alignment feature
490b raised relief alignment feature
492 raised relief alignment feature
494a first set of raised relief alignment features
494b first set of raised relief alignment features
495a matching alignment feature
495b matching alignment feature
496a second set of raised relief alignment features
496b second set of raised relief alignment features
497a matching alignment feature
497b matching alignment feature
498a second set of raised relief alignment features
498b second set of raised relief alignment features
499a matching alignment feature
499b matching alignment feature
499c matching alignment feature
500a first flexographic printing station
500b second flexographic printing station
500c third flexographic printing station
510a first plate cylinder
510b second plate cylinder
510c third plate cylinder
515a mounting tape
515b mounting tape
515c mounting tape
520 platen
550 platen rails
552 position
554 position
556 position
560a chambered doctor blades with ink
560b chambered doctor blades with ink
560c chambered doctor blades with ink
562a first ink
562b second ink
562c third ink
570a gravure cylinder
570b gravure cylinder
570c gravure cylinder
600 receiver
612 first printed image
612a-f first set of printed image features
614 second printed image
614a-e second set of printed image features
616 third printed image
616a-e third set of printed image features
620 printed functional receiver
700a first stamp printing station
700b second stamp printing station
700c third stamp printing station
702 first stamp
704 second stamp
706 third stamp
710a first stamp backing plate
710b second stamp backing plate
710c third stamp backing plate
715a mounting tape
715b mounting tape
715c mounting tape
720 platen
750 platen rails
752 platen position
754 platen position
756 platen position
760a chambered doctor blade
760b chambered doctor blade
760c chambered doctor blade
762a first ink
762b second ink
762c third ink
770a gravure cylinders
770b gravure cylinders
770c gravure cylinders
780 receiver
782 first printed image
782a-f first set of printed image features
784 second printed image
784a-e second set of printed image features
786 third printed image
786a-e third set of printed image features
790 printed functional receiver

1. A method of aligning a stamp to a stamp backing plate comprising:
mounting a fixture with a first alignment feature to a platen;
providing a first stamp with a second alignment feature which matches the first alignment feature;
aligning the first stamp to the fixture using the first and second alignment features;
transferring the first stamp from the fixture to a first stamp backing plate maintaining registration;
providing a second stamp with a third alignment feature which matches the first alignment feature;
aligning the second stamp to the fixture using the first and third alignment features; and
transferring the second stamp from the fixture to a second stamp backing plate maintaining registration.

2. The method of claim 1 wherein the first alignment feature is selected from a group consisting of a wire, a bar, and combinations thereof.

3. The method of claim 1 wherein the second and third alignment features are selected from a group consisting of a notch, a reverse line, a line, an edge, a series of lines and a combination thereof.

4. The method of claim 1 wherein the first stamp has a raised surface containing an image and the second alignment feature; and
the second stamp has a raised surface containing an image and the third alignment feature.

5. The method of claim 4 wherein the raised images and the alignment features are in register.

6. The method of claim 1 wherein the first stamp mounted on the first stamp backing plate is in a first stamp printing station; and
the second stamp mounted on the second stamp backing plate is in a second stamp printing station.

7. The method of claim 6 wherein the first stamp mounted on the first stamp backing plate in a first stamp printing station prints a first image onto a receiver; and
the second stamp mounted on the second stamp backing plate in the second stamp printing station prints a second image in register to the first image onto the receiver.

8. The method of claim 7 wherein the receiver is selected from a group consisting of paper, plastic, silicon, glass, metal, semiconductor, metalized film, film, ceramic and combinations thereof.

9. The method of claim 7 wherein the printed receiver is a printed functional receiver.

10. The method of claim 9 wherein the printed functional receiver is selected from a group consisting of a an electronic device, a memory, a conductive device, a light emitting device, a light detector device, a diode junction, a capacitive device, a strain detector, a stress detector, a mechanical device, a three dimensional object, a multi-colored graphic image and combinations thereof.
